(19) United States
(12) Patent Application Publication
(10) Pub. No.: US 2018/0060776 A1
(43) Pub. Date: Mar. 1, 2018

(54) Optimizing Selection of Battery Electric Vehicles to Perform Delivery Tasks

(71) Applicant: Ford Global Technologies, LLC, Dearborn, MI (US)

(72) Inventors: Nayaz Khalid Ahmed, Canton, MI (US); Ramzi Ahmad Chraim, Dearborn, MI (US); Ray C. Siciak, Ann Arbor, MI (US)

(21) Appl. No.: 15/249,876

(22) Filed: Aug. 29, 2016

(51) Int. Cl. G06Q 10/06; G05D 1/02; G01C 21/34; G01C 21/36; G07C 5/00; G07C 5/08; G06Q 10/08

(52) U.S. Cl. CPC G06Q 10/06313; G05D 1/0297; G01C 21/343; G06Q 10/083; G07C 5/008; G07C 5/0808; G01C 21/3679

(57) ABSTRACT

The present invention extends to methods, systems, and computer program products for optimizing selection of battery electric vehicles to perform delivery tasks. Within a group of battery electric vehicles (“BEVs”), a BEV is selected to perform a delivery task based on battery charge status. The BEV can be selected based on one or more of: proximity to a requested pick up location, battery state-of-charge (“SOC”), charging station proximity to a requested delivery location, and charging station port availability (e.g., wait time to access a charging port). BEV selection can be optimized such that a BEV arrives at a charging station with optimal remaining SOC. Thus, the distance to charging stations can be optimized while meeting the needs of customer requests to get a delivery from a pickup location to delivery location. In some aspects, autonomous vehicle technology is used to operate BEV's.

### CROSS-REFERENCE TO RELATED APPLICATIONS

Not applicable.

### BACKGROUND

### 1. Field of the Invention

This invention relates generally to the field of vehicle management, and, more particularly, to optimizing selection of battery electric vehicles to perform delivery tasks.

### 2. Related Art

Conventionally, “on-demand” transportation and delivery services have used combustion engine vehicles and/or hybrid electric vehicles. The range of these types of vehicles is limited by how much fuel is available to complete a requested service. However, the abundancy of gasoline stations permits a vehicle to be filled up at virtually anytime within urban environments.

Battery electric vehicles have reduced operating costs relative to combustion engine vehicles and full hybrid electric vehicles. Due to the reduced operating costs, battery electronic vehicles are being used more frequently for “on-demand” transportation and delivery services. However, due to limited charging infrastructure and time to fully recharge, use of battery electric vehicles is constrained in many environments. For example, it often requires a longer trip to get to a charging station than to a gasoline station. It can also take much longer to recharge batteries of a battery electric vehicle than to fill up a gas tank on a combustion engine vehicle or a hybrid electric vehicle.

### BRIEF DESCRIPTION OF THE DRAWINGS

The specific features, aspects and advantages of the present invention will become better understood with regard to the following description and accompanying drawings where:

FIG. 1 illustrates an example block diagram of a computing device.

FIG. 2 illustrates an example environment that facilitates optimizing selection of battery electric vehicles to perform delivery tasks.

FIG. 3 illustrates a flow chart of an example method for optimizing selection of battery electric vehicles to perform delivery tasks.

FIG. 4 illustrates an example environment for selecting a battery electric vehicle to perform a delivery task.

FIG. 5 illustrates an example environment for selecting a battery electric vehicle to perform a delivery task.

FIG. 6 illustrates an example equation for estimating total battery consumption to perform a delivery request.

FIG. 7 illustrates an example equation for estimating battery consumption per segment of performing a delivery request.

### DETAILED DESCRIPTION

The present invention extends to methods, systems, and computer program products for optimizing selection of battery electric vehicles to perform delivery tasks.

Within a group of battery electric vehicles (“BEVs”), a BEV is selected to perform a delivery task (e.g., deliver a person, deliver an animal, deliver a package, deliver some other item, etc.). The BEV can be selected based on one or more of: proximity to a requested pick up location, battery state-of-charge (“SOC”), charging station proximity to a requested delivery location, and charging station port availability (e.g., wait time to access a charging port). BEV selection can be optimized such that a BEV arrives at a charging station with optimal remaining SOC. As such, the distance to charging stations can be optimized while meeting the needs of customer requests to get a delivery from a pickup location to delivery location.

In some aspects, autonomous vehicle technology is used to operate BEV's. Using autonomous vehicle technology, selection of BEVs to perform delivery tasks can be optimized with limited, if any, human intervention.

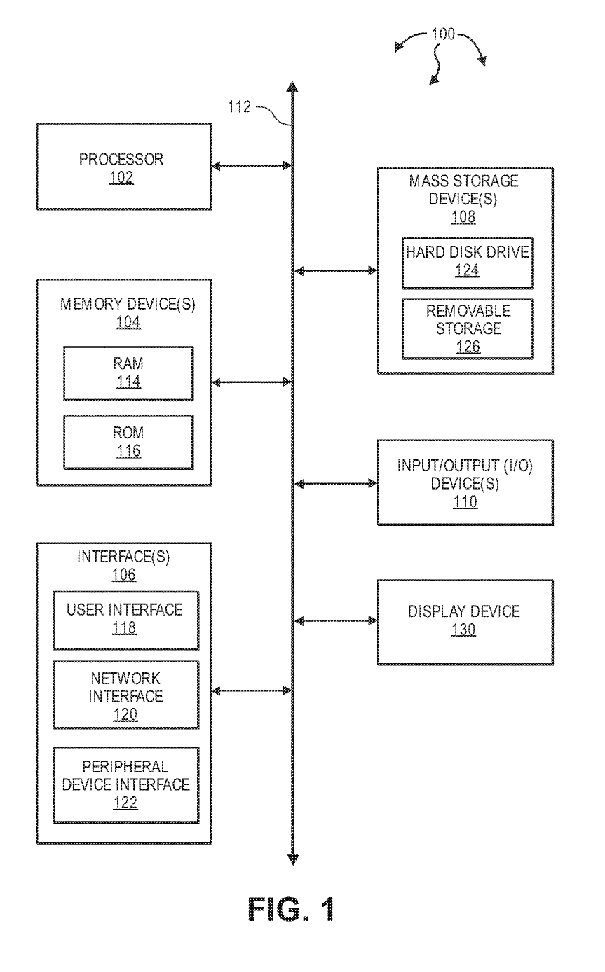

Aspects of the invention can be implemented in a variety of different types of computing devices. FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer storage media, such as cache memory.

Memory device(s) 104 include various computer storage media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer storage media, such as magnetic tapes, magnetic disks, optical disks, solid state memory (e.g., Flash memory), and so forth. As depicted in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, barcode scanners, microphones, monitors or other display devices, speakers, printers, network interface cards, modems, cameras, lenses, radars, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments as well as humans. Example interface(s) 106 can include any number of different network interfaces 120, such as interfaces to personal area networks (PANs), local area networks (LANs), wide area networks (WANs), wireless networks (e.g., near field communication (NFC), Bluetooth, Wi-Fi, etc., networks), and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

In this description and the following claims, a “battery electric vehicle” (BEV) is defined as type of electric vehicle (EV) that uses chemical energy stored in rechargeable battery packs. BEVs use electronic motors and motor controllers for propulsion. BEVs include bicycles, scooters, skateboards, rail cars, watercraft, forklifts, buses, trucks, cars, etc. BEVs can also be referred to as battery-only electric vehicles (BOEVs) or all-electric vehicles.

In this description and the following claims, “Plug-in electric vehicles” (PEVs) is defined as a subcategory of EVs that includes BEVs, plug-in hybrid vehicles, (PHEVs), and electric vehicle conversions of hybrid electric vehicles and conventional internal combustion engine vehicles.

In this description and in the following claims, a “delivery task” is defined a task for delivering a person, an animal, an item, a package, etc., from a pick-up location to a delivery location. A delivery task can also include delivering different combinations and/or quantities of: a person or persons, an animal or animals, an item or items, a package or packages, etc., from a pick-up location to a delivery location.

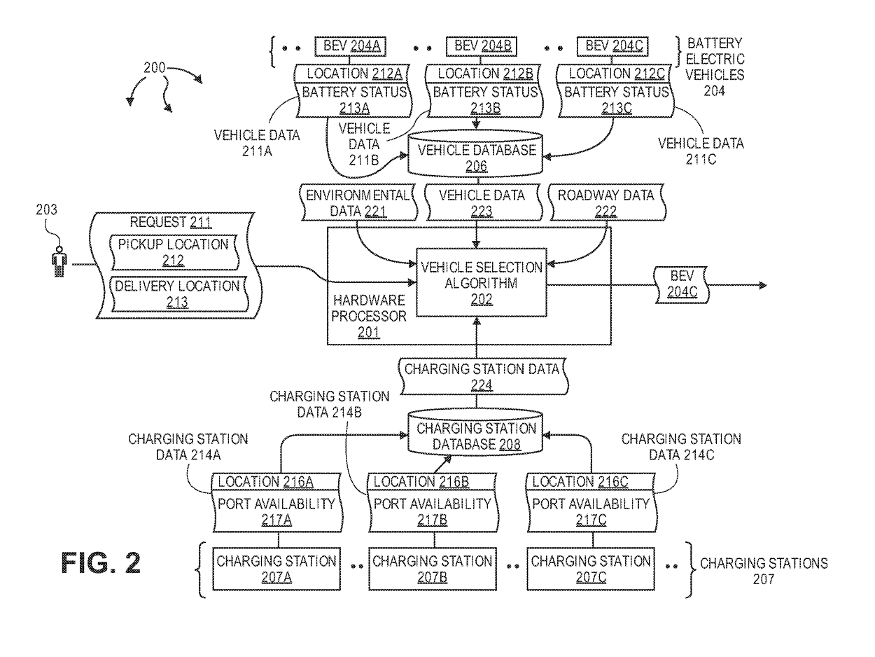

FIG. 2 illustrates an example environment 200 that facilitates optimizing selection of battery electric vehicles to perform delivery tasks. Referring to FIG. 2, environment 200 includes hardware processor 201, vehicle selection algorithm 202, customer 203, battery electric vehicles (BEVs) 204, vehicle database 206, charging stations 207, charging station database 208. Hardware processor 201, vehicle selection algorithm 202, customer 203, battery electric vehicles (BEVs) 204, vehicle database 206, charging stations 207, and charging station database 208 can be connected to (or be part of) a network, such as, for example, a system bus, a Local Area Network (“LAN”), a Wide Area Network (“WAN”), and even the Internet. Accordingly, hardware processor 201, vehicle selection algorithm 202, customer 203, battery electric vehicles (BEVs) 204, vehicle database 206, charging stations 207, charging station database 208 as well as any other connected computer systems and their components (e.g., weather monitoring systems, traffic monitoring and management systems, mapping systems, etc.) can create and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

In general, each of battery electric vehicles (BEVs) 204 is available to perform delivery tasks. All of BEVs 204 can operate within the same general area, such as, for example, a city, a county, or a metropolitan area. Each of BEVs 204 can include one or more battery packs used for propulsion.

In one aspect, BEVs 204 are part of a unified fleet of vehicles controlled by a single entity. For example, BEVs 204 can be a fully autonomous taxi fleet with no customer input used to maneuver BEVs 204. In another aspect, each of BEVs 204 (or one or more different subsets of BEVs 204) are controlled by different entities. For example, each of BEVs 204A, 204B, and 204C can be under the control of different entities. The ellipses before, between, and after BEVs 204A, 204B, and 204C represent that any number of other BEVs can also be operating in the same general area as BEVs 204A, 204B, and 204C.

In one aspect, one or more of BEVs 204 include autonomous vehicle (AV) technology permitting the one or more BEVs 204 to operate without a human driver.

From time to time or at specified intervals, each of BEVs 204 can send vehicle data to vehicle database 206. Vehicle data can include vehicle location, battery state-of-charge (SOC), battery operating characteristics (e.g., battery type, battery age, battery performance degradation due to vehicle age, etc.), other vehicle operating characteristics of a BEV, etc. In one aspect, vehicle database 206 is included in a cloud service. BEVs 204 can send vehicle data to vehicle database 206 at different times as operating and network conditions permit. Vehicle selection algorithm 202 can access vehicle data from vehicle database 206 when assigning a BEV to perform a delivery task.

In alternate embodiments, each of BEVs 204 can send vehicle data directly to vehicle selection algorithm 202.

Charging stations 207 can be located within the same general area in which BEVs 204 operate. Each of charging stations 207 can include one or more charging ports for charging BEVs. Groups of one or more of charging stations 207 can be stationed at one or more different locations with the general area. For example, charging stations 207A and 207B can be at the same location while charging station 207C is at a different location. In another example, each of charging stations 207A, 207B, and 207C are at different locations. The ellipses before, between, and after charging stations 207A, 207B, and 207C represent that any number of other charging stations can also be stationed in the same general area as charging stations 207A, 207B, and 207C.

Each of charging stations 207 can be capable of charging BEVs. In one aspect, one or more of charging stations 207 are fast charging stations and/or super charging stations. Fast charging stations and/or super charging stations can charge BEVs at a rate of up to 40 miles every 10 minutes. As such, fast charging stations and/or super charging stations can charge a fully depleted BEV up to 160 miles in approximately 40 minutes.

From time to time or at specified intervals, each of charging stations 207 can send charging station data to charging station database 208. Charging station data can include charging station location, charging station type, charging station recharge rate, total number of charging ports, number of available charging ports, etc. In one aspect, charging station database 208 is included in a cloud service. Charging stations 207 can send charging station data to charging station database 208 at different times as operating and network conditions permit. Vehicle selection algorithm 202 can access charging station data from charging station database 208 when assigning a BEV to perform a delivery task.

In alternate embodiments, each of charging stations 207 can send charging station data directly to vehicle selection algorithm 202.

From time to time, each of BEVs 204 can travel to one of charging stations 207 to recharge batteries. In one aspect, one or more of charging stations 207 include components for charging BEVs that include autonomous vehicle (AV) technology without the need for human intervention.

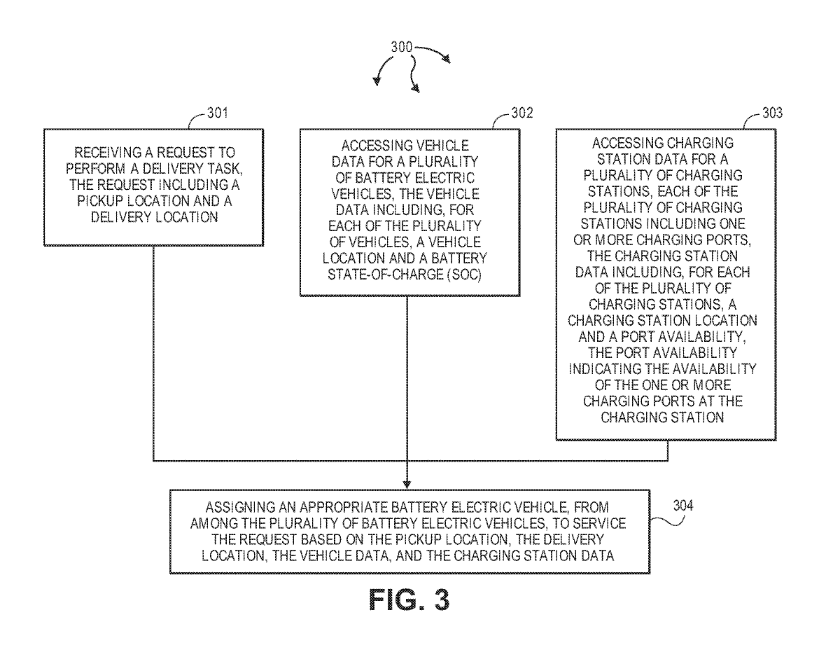

FIG. 3 illustrates a flow chart of an example method 300 for optimizing selection of battery electric vehicles to perform delivery tasks. Method 300 will be described with respect to the components and data of environment 200.

Method 300 includes receiving a request to perform a delivery task, the request including a pickup location and a delivery location (301). For example, vehicle selection algorithm 202 can receive request 211 from customer 203. Request 211 includes pickup location 212 and delivery location 213. Customer 203 can be a customer that requests a ride from pickup location 212 to delivery location 213 or that requests delivery of another item from pickup location 212 to delivery location 213. In one aspect, customer 203 uses an application (an “app”) at a mobile device to submit request 211 to vehicle selection algorithm 202.

Method 300 includes accessing vehicle data for the plurality of battery electric vehicles, the vehicle data including, for each of the plurality of vehicles, a vehicle location and a battery state-of-charge (SOC) (302). For example, vehicle selection algorithm 202 can access vehicle data 223 for BEVs 204. For each of BEVs 204, vehicle data 223 can include a location of the BEV and a battery status. The battery status indicates the state-of-charge (SOC) for batteries providing propulsion for the BEV.

In one aspect, from time to time or at specified intervals (e.g., when operating and/or network conditions permit), each of BEVs 204 submits vehicle data to vehicle database 206. For example, BEVs 204A, 204B, and 204C can submit vehicle data 211A, 211B, and 211C respectively to vehicle database 206. Vehicle selection algorithm 202 then accesses vehicle data 223 from vehicle database 206. For example, vehicle algorithm 202 can query vehicle database 206 for specified vehicle data.

In another aspect, from time to time or at specified intervals (e.g., when operating and/or network conditions permit), each of BEVs 204 submits vehicle data directly to vehicle selection algorithm 202. For example, BEVs 204A, 204B, and 204C can submit vehicle data 211A, 211B, and 211C respectively directly to vehicle selection algorithm 202. Vehicle selection algorithm 202 then filters vehicle data 223 from vehicle data 211A, 211B, and 211C.

Vehicle data for each of BEVs 204 can include one or more of: vehicle location, battery state-of-charge (SOC), battery operating characteristics (e.g., battery type, battery age, battery performance degradation due to vehicle age, etc.), and other vehicle operating characteristics of a BEV. For example, vehicle data 211A can include location 212A indicating the location of BEV 204A and battery status 213A indicating the state-of-charge (SOC) for batteries providing propulsion for BEV 204A. Similarly, vehicle data 211B can include location 212B indicating the location of BEV 204B and battery status 213B indicating the state-of-charge (SOC) for batteries providing propulsion for BEV 204B. Likewise, vehicle data 211C can include location 212C indicating the location of BEV 204C and battery status 213C indicating the state-of-charge (SOC) for batteries providing propulsion for BEV 204C.

Vehicle data 223 can include at least a subset of vehicle data submitted by BEVs 204. In one aspect, vehicle data 223 includes at least vehicle data 211A, 211B, and 211C.

Method 300 includes accessing charging station data for a plurality of charging stations, each of the plurality of charging stations including one or more charging ports, the charging station data including, for each of the plurality of charging stations, a charging station location and a port availability, the port availability indicating the availability of the one or more charging ports at the charging station (303). For example, vehicle selection algorithm 202 can access charging station data 224 for charging stations 207. For each of charging stations 207, charging station data 224 can include a location of the charging station and a port availability. The port availability indicates the availability of the one or more charging ports at the charging station.

In one aspect, from time to time or at specified intervals (e.g., when operating and/or network conditions permit), each of charging stations 207 submits charging station data 207 to charging station database 208. For example, charging stations 207A, 207B, and 207C can submit charging station data 214A, 214B, and 214C respectively to charging station database 208. Vehicle selection algorithm 202 then accesses charging station data 224 from charging station database 208. For example, vehicle algorithm 202 can query charging station database 208 for specified charging station data.

In another aspect, from time to time or at specified intervals (e.g., when operating and/or network conditions permit), each of charging stations 207 submits charging station data directly to vehicle selection algorithm 202. For example, charging stations 207A, 207B, and 207C can submit charging station data 214A 214B, and 214C respectively directly to vehicle selection algorithm 202. Vehicle selection algorithm 202 then filters charging station data 224 from charging station data 214A, 214B, and 214C.

Charging station data for each of charging stations 207 can include one or more of: charging station location, charging station type, charging station recharge rate, total number of charging ports, number of available charging ports, etc. For example, charging station data 214A can include location 216A indicating the location of charging station 207A and port availability 217A indicating availability of charging ports at charging station 207A. Similarly, charging station data 214B can include location 216B indicating the location of charging station 207B and port availability 217B indicating availability of charging ports at charging station 207B. Likewise, charging station data 214C can include location 216C indicating the location of charging station 207C and port availability 217C indicating availability of charging ports at charging station 207C.

Charging station data 224 can include at least a subset of vehicle data submitted by charging stations 207. In one aspect, vehicle data 224 includes at least charging station data 214A, 214B, and 214C.

Method 300 includes assigning an appropriate battery electric vehicle, from among the plurality of battery electric vehicles, to service the request based on the pickup location, the delivery location, the vehicle data, and the charging station data (304). For example, vehicle selection algorithm 202 can assign BEV 204C to service request 211. Vehicle selection algorithm 202 can assign BEV 204A based on pickup location 212, delivery location 213, vehicle data 223, and charging station data 224.

In some aspects, vehicle selection algorithm 202 also considers environmental data (e.g., temperature, other weather conditions, etc.) and/or roadway data (e.g., speed limits, traffic congestion, etc.) when assigning a BEV to service a request. For example, vehicle selection algorithm 202 can consider environmental data 221 and roadway data 222 when assigning BEV 204C to service request 211.

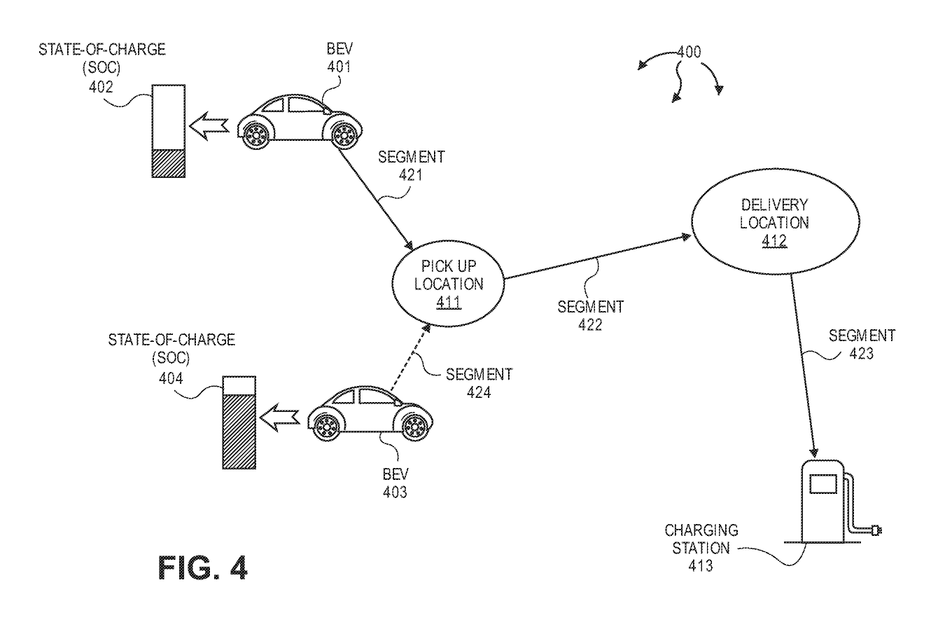

Turning now to FIG. 4, FIG. 4 illustrates an example environment 400 for selecting a battery electric vehicle to perform a delivery task. Within environment 400, a request has been received to make a delivery from pickup location 411 to delivery location 412. A vehicle selection algorithm (similar to vehicle selection algorithm 202) considers a number of available BEVs, including BEVs 401 and 403, to potentially service the request. As depicted, BEV 401 has batteries with state-of-charge (SOC) 402 (less charged) and BEV 403 has batteries with state-of-charge (SOC) 404 (more charged). The shaded portion of SOC 402 and SOC 403 indicate how close batteries are to being fully charged. As such, comparing SOC 404 to SOC 402 indicates that batteries at BEV 403 are closer to fully charged than batteries at BEV 401.

In one aspect, one or more of BEVs 401 and 403 include autonomous vehicle (AV) technology permitting the one or more BEVs 401 and 403 to operate without a human driver.

For each of BEVs 401 and 403, the vehicle selection algorithm estimates the total battery consumption for the BEV to complete the delivery. For example, the vehicle selection algorithm estimates the battery consumption for BEV 401 to travel segment 421 (i.e., to drive from a current location to pick up location 411) and to travel segment 422 (i.e., to drive from pick up location 411 to delivery location 412). Similarly, the vehicle selection algorithm estimates the battery consumption for BEV 403 to travel segment 424 (i.e., to drive from a current location to pick up location 411) and to travel segment 422 (i.e., to drive from pick up location 411 to delivery location 412). The vehicle selection algorithm also estimates the battery consumption for each of BEV 401 and BEV 402 to travel segment 423 (i.e., from delivery location 412 to charging station 413).

From the battery consumption estimates, the vehicle selection algorithm estimates what SOC 403 and SOC 404 would be when BEV 401 and 402 respectively arrive at charging station 413. The selection algorithm determines from the estimates that BEV 401 would be more in need of charging after servicing the request. As such, the selection algorithm assigns BEV 401 to service the request and, after completing the delivery, travel to charging station 413 to recharge.

Thus, the vehicle selection algorithm estimates total battery consumption for each available BEV to service a request and, if appropriate, recharge. In one aspect, an estimate of total battery consumption to service a request is calculated as the sum of different segments, including a pickup segment, a trip segment, and, if appropriate, a recharge segment. For a pickup segment, the vehicle selection algorithm calculates battery consumption for a BEV to travel from a current location to a pickup location. For a trip segment, the vehicle selection algorithm calculates battery consumption for a BEV to travel from a pickup location to a delivery location.

For a recharge segment, the vehicle selection algorithm calculates battery consumption for a BEV to travel from a delivery location to a next available charging station. In one aspect, recharging is performed when the BEV has reached an optimal minimum allowed SOC. Optimal SOC can be the lowest SOC that maximizes battery life. A recharge segment may not be appropriate for BEVs within a specified proximity to a delivery request.

Total battery consumption to service a request can also include a charge port availability penalty. A charge port availability penalty can be estimated from time lost waiting for an available charge port and/or driving to a further charging station.

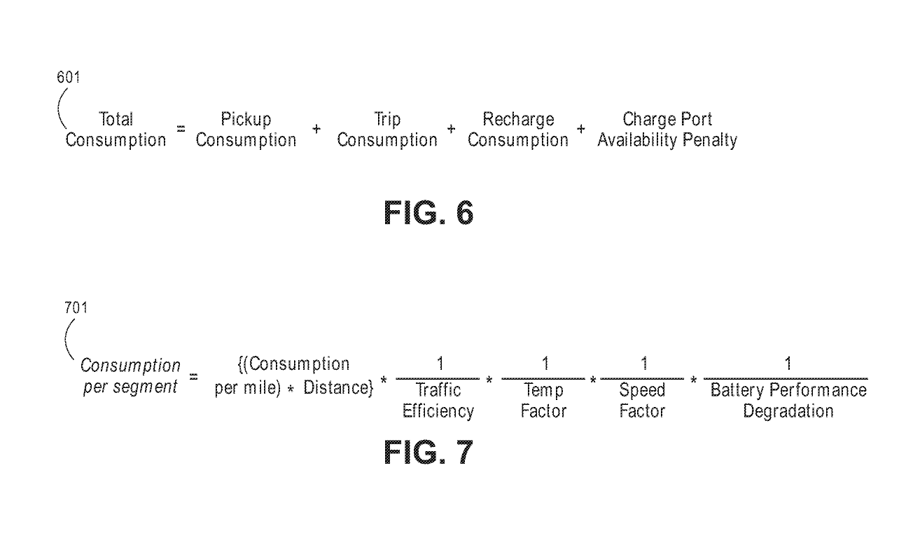

Thus, total battery consumption to service a request can be estimated from equation 601 in FIG. 6. Battery consumption per travel segment (e.g., a pickup segment, a trip segment, or a recharge segment) can be estimated as a function of distance, traffic, ambient temperature, and vehicle speed. For example, battery consumption per travel segment can be estimated from equation 701 in FIG. 7.

In equation 701, SOC per mile is a percent of battery energy use per mile for a BEV at the batteries beginning of life, in an ambient temperature (e.g., 27° C.) and optimal driving conditions (e.g., 15 mph). Distance is the total driving distance from the vehicle's starting location to the charging station. This distance includes the distance for the pickup and delivery event.

Still referring to equation 701, traffic efficiency represents the impact of road construction, various terrain changes, etc., which increases vehicle idle time during transit. Temperature factor represents that a higher temperature has a tendency to negatively impact the BEV SOC. Speed factor accounts for the real world driving speed allowed at the time of request. Battery performance degradation takes into account the decrease in battery SOC as a vehicle ages.

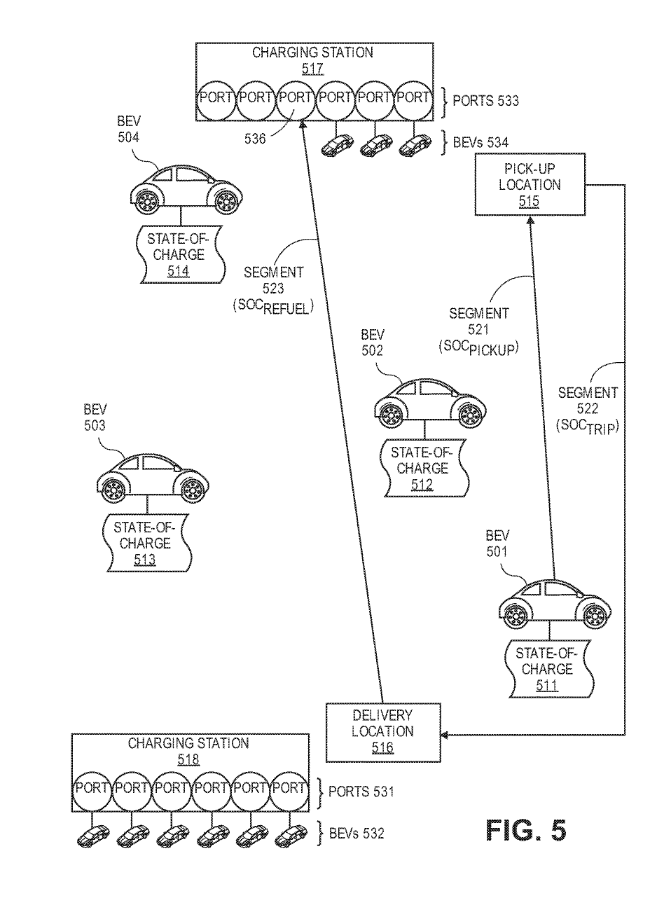

For some delivery tasks, the use of multiple charging stations is possible but the charging station closest to the delivery location is full. A vehicle selection algorithm handles full charging stations per the “Charge Port Availability Penalty” in equation 601. FIG. 5 illustrates an example environment 500 for selecting a battery electric vehicle to perform a delivery task.

Within environment 500, a request has been received to make a delivery from pickup location 515 to delivery location 516. A vehicle selection algorithm (similar to vehicle selection algorithm 202) considers a number of available BEVs, including BEVs 501, 502, 503, and 504, to potentially service the request. As depicted, BEV 501 has batteries with state-of-charge (SOC) 511, BEV 502 has batteries with state-of-charge (SOC) 512, BEV 503 has batteries with state-of-charge (SOC) 513, and BEV 504 has batteries with state-of-charge (SOC) 514.

In one aspect, one or more of BEVs 501, 502, 503, and 504 include autonomous vehicle (AV) technology permitting the one or more BEVs 501, 502, 503, and 504 to operate without a human driver.

Charging station 518 has ports 531 that are fully in use to recharge BEVs 532. Charging station 517 has ports 533. Some of ports 533 are in use to recharge BEVs 534. Other ports, including port 536, are available.

Based on equation 601, the vehicle selection algorithm can assign BEV 501 to service the request. The vehicle selection algorithm can estimate battery consumption for segments 521, 522, and 523 as well as estimate charge port availability penalty based on charging station 518 being full. The vehicle selection algorithm can determine that SOC 511 would be closest to the optimal minimum allowed SOC after BEV 501 travels segments 521, 522, and 523 relative to BEVs 502, 503, and 504 traveling corresponding segments to service the request.

In some aspects, recharging is not necessarily performed at the optimal SOC. There may be a lost opportunity cost by not charging sooner than reaching optimal SOC. For example, when a BEV is 10% above the optimal SOC and it is close to a charging station, it may be beneficial to charge and be ready to accept a delivery that requires >10% SOC.

In other aspects, a learning algorithm uses drive history for BEVs to determine what is an optimal SOC for each BEV at each location based on a map of charging stations in an area.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can transform information between different formats, such as, for example, delivery requests, pickup locations, delivery locations, vehicle data, vehicle locations, battery status, charging station data, charging station locations, charging station port availability, environmental data, roadway data, assigned BEVs, etc.

System memory can be coupled to the one or more processors and can store instructions (e.g., computer-readable instructions, computer-executable instructions, etc.) executed by the one or more processors. The system memory can also be configured to store any of a plurality of other types of data generated by the described components, such as, for example, delivery requests, pickup locations, delivery locations, vehicle data, vehicle locations, battery status, charging station data, charging station locations, charging station port availability, environmental data, roadway data, assigned BEVs, etc.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash or other vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

What is claimed:

1. A method for selecting a vehicle for a task, comprising:
receiving a request to perform a delivery task, the request including a pickup location and a delivery location;
accessing vehicle data for a plurality of battery electric vehicles;
accessing charging station data for a plurality of charging stations; and
assigning a battery electric vehicle to service the request based on the pickup location, the delivery location, the vehicle data, and the charging station data.

2. The method of claim 1, wherein accessing vehicle data for a plurality of battery electric vehicles comprises accessing, for each battery electric vehicle, a location of the battery electronic vehicle and a state-of-charge (SOC) for a battery system contained in the battery electric vehicle; and
wherein assigning a battery electric vehicle to service the request comprises assigning a battery electronic vehicle, from among the plurality of battery electric vehicles, based on the proximity of the pickup location to the location of the battery electric vehicle and the state-of-charge (SOC) for the battery system contained in the battery electric vehicle.

3. The method of claim 1, wherein accessing charging station data for a plurality of charging stations comprises accessing, for each of the plurality of charging stations, a charging station location and a port availability, the port availability indicating the availability of the one or more charging ports at the charging station; and
wherein assigning a battery electric vehicle to service the request comprises assigning a battery electronic vehicle, from among the plurality of battery electric vehicles, based on the proximity of the delivery location to the charging station location of a particular charging station and the port availability of the particular charging station.

4. The method of claim 1, wherein assigning a battery electric vehicle to service the request comprises:
estimating battery consumption for each segment of a multi-segment trip to service the request, the segments of the multi-segment trip including: (a) travel from the vehicle location of the battery electric vehicle to the pickup location, (b) travel from the pickup location to the delivery location, and (c) travel from the delivery location to a charging station location of a particular charging station; and
assigning the battery electric vehicle based on the estimated battery consumption.

5. The method of claim 4, wherein estimating battery consumption for each segment of a multi-segment trip comprises for each segment of the multi-segment trip, estimating battery consumption for the battery electric vehicle based on: traffic efficiency for the segment, external temperature, driving speed permitted for the segment, and battery performance degradation at the battery electric vehicle.

6. The method of claim 1, wherein the plurality of battery electric vehicles comprises a plurality of autonomously operating vehicles.

7. A system, the system connected to a plurality of battery electric vehicles and a plurality of charging stations, each of the plurality of charging stations including one or more charging ports, the system comprising:
one or more processors;
system memory coupled to one or more processors, the system memory storing instructions that are executable by the one or more processors;
the one or more processors configured to execute the instructions stored in the system memory to select a battery electric vehicle, from among the plurality of battery electric vehicles to perform a delivery task, including the following:
receive a request to perform a delivery task, the request including a pickup location and a delivery location;
access vehicle data for the plurality of battery electric vehicles, the vehicle data including, for each of the plurality of vehicles, a vehicle location and a battery state-of-charge (SOC);
access charging station data for the plurality of charging stations, the charging station data including, for each of the plurality of charging stations, a charging station location; and
assign an appropriate battery electric vehicle, from among the plurality of battery electric vehicles, to service the request based on the pickup location, the delivery location, the vehicle data, and the charging station data.

8. The system of claim 7, wherein the one or more processors configured to execute the instructions stored in the system memory to assign an appropriate battery electric vehicle, from among the plurality of battery electric vehicles, to service the request comprise the one or more processors configured to execute the instructions stored in the system memory to assign the appropriate battery electric vehicle to service the request based on the proximity of the vehicle location for the appropriate battery electric vehicle to the pickup location.

9. The system of claim 7, wherein the one or more processors configured to execute the instructions stored in the system memory to assign an appropriate battery electric vehicle, from among the plurality of battery electric vehicles, to service the request comprise the one or more processors configured to execute the instructions stored in the system memory to assign the appropriate battery electric vehicle to service the request based on the state-of-charge (SOC) for the appropriate battery electric vehicle.

10. The system of claim 7, wherein the one or more processors configured to execute the instructions stored in the system memory to assign an appropriate battery electric vehicle, from among the plurality of battery electric vehicles, to service the request comprise the one or more processors configured to execute the instructions stored in the system memory to assign the appropriate battery electric vehicle to service the request based on the proximity of a particular charging station, from among the plurality of charging stations, to the delivery location.

11. The system of claim 10, wherein the one or more processors configured to execute the instructions stored in the system memory to access charging station data for the plurality of charging stations comprises the one or more processors configured to execute the instructions stored in the system memory to access charging station data for the plurality of charging stations, the charging data including, for each of the plurality of charging stations, a port availability, the port availability indicating the availability of the one or more charging ports at the charging station.

12. The system of claim 11, wherein the one or more processors configured to execute the instructions stored in the system memory to assign an appropriate battery electric vehicle, from among the plurality of battery electric vehicles, to service the request comprise the one or more processors configured to execute the instructions stored in the system memory to assign the appropriate battery electric vehicle to service the request based the port availability at the particular charging station.

13. The system of claim 10, wherein the one or more processors configured to execute the instructions stored in the system memory to assign an appropriate battery electric vehicle, from among the plurality of battery electric vehicles, to service the request comprise the one or more processors configured to execute the instructions stored in the system memory to:
calculate battery consumption for each segment of a multi-segment trip to service the request, the segments of the multi-segment trip including: (a) travel from the vehicle location of the appropriate battery electric vehicle to the pickup location, (b) travel from the pickup location to the delivery location, and (c) travel from the delivery location to the charging station location of the particular charging station; and
assign the appropriate battery electric vehicle based on the calculated battery consumption.

14. The system of claim 13, wherein the one or more processors configured to execute the instructions stored in the system memory to calculate battery consumption for each segment of a multi-segment trip to service the request comprise the one or more processors configured to execute the instructions stored in the system memory to, for each segment of the multi-segment trip, calculate battery consumption at the battery electric vehicle based on: traffic efficiency for the segment, external temperature, driving speed permitted for the segment, and battery performance degradation at the appropriate battery electric vehicle.

15. The system of claim 7, wherein the one or more processors configured to execute the instructions stored in the system memory to assign an appropriate battery electric vehicle, from among the plurality of battery electric vehicles, to service the request comprise the one or more processors configured to execute the instructions stored in the system memory to optimize remaining state-of-charge based on the pickup location, the delivery location, the vehicle data, and the charging station data such that the selected appropriate battery electric vehicle arrives at a charging station with optimal remaining state-of-charge to maximize battery life, the charging station selected from among the plurality of charging stations.

16. A computer-implemented method for selecting a battery electric vehicle, from among a plurality of battery electric vehicles to perform a delivery task, the method comprising a hardware processor:
receiving a request to perform a delivery task, the request including a pickup location and a delivery location;
accessing vehicle data for the plurality of battery electric vehicles, the vehicle data including, for each of the plurality of vehicles, a vehicle location and a battery state-of-charge (SOC);
accessing charging station data for a plurality of charging stations, each of the plurality of charging stations including one or more charging ports, the charging station data including, for each of the plurality of charging stations, a charging station location and a port availability, the port availability indicating the availability of the one or more charging ports at the charging station; and
assigning an appropriate battery electric vehicle, from among the plurality of battery electric vehicles, to service the request based on the pickup location, the delivery location, the vehicle data, and the charging station data.

17. The computer-implemented method of claim 16, wherein assigning an appropriate battery electric vehicle, from among the plurality of battery electric vehicles, to service the request comprises assigning the appropriate battery electric vehicle to service the request based on the proximity of the vehicle location for the appropriate battery electric vehicle to the pickup location.

18. The computer-implemented method of claim 16, wherein assigning an appropriate battery electric vehicle, from among the plurality of battery electric vehicles, to service the request comprises assigning the appropriate battery electric vehicle to service the request based on:
the proximity of a particular charging station, from among the plurality of charging stations, to the delivery location; and
the port availability at the particular charging station.

19. The computer-implemented method of claim 16, wherein assigning an appropriate battery electric vehicle, from among the plurality of battery electric vehicles, to service the request comprises:
calculating battery consumption for each segment of a multi-segment trip to service the request, the segments of the multi-segment trip including: (a) travel from the vehicle location of the appropriate battery electric vehicle to the pickup location, (b) travel from the pickup location to the delivery location, and (c) travel from the delivery location to the charging station location of the particular charging station, including for each segment:
estimating battery consumption for the appropriate battery electric vehicle based on: traffic efficiency for the segment, external temperature, driving speed permitted for the segment, and battery performance degradation at the appropriate battery electric vehicle; and
assigning the appropriate battery electric vehicle based on the calculated battery consumption.

20. The computer-implemented method of claim 1, wherein the plurality of battery electric vehicles comprises a plurality of autonomously operating vehicles.
